(19) United States
(12) Patent Application Publication
(10) Pub. No.: US 2016/0180048 A1
(43) Pub. Date: Jun. 23, 2016

(54) CLOUD-BASED MEDICAL INFORMATION RETRIEVAL METHOD AND SYSTEM THEREOF

(71) Applicant: TZU-HUNG LIN, Taipei (TW)

(72) Inventors: Tzu-Hung LIN, Taipei (TW); Kuang-Lung KO, Taipei (TW); Chia-Cheng HUNG, New Taipei City (TW); Yi-Ning SU, Taipei (TW)

(21) Appl. No.: 14/975,411

(22) Filed: Dec. 18, 2015

(30) Foreign Application Priority Data
Dec. 19, 2014 (TW) 103144499

(51) Int. Cl. G06F 19/00; H04L 29/06

(52) U.S. Cl. CPC G06F 19/3418; G06F 19/322; H04L 63/102

(57) ABSTRACT

The present invention is to provide a cloud-based retrieval method of medical information and system thereof. The method comprises (a) generating an identification code corresponding to a personally identifiable information about a subject; (b) identifying a tested item for the subject to generate a medical information; (c) establishing a connection between the medical information and the subject; (d) submitting a retrieval request data including at least a part of personally identifiable information; (e) executing an algorithm to calculate the retrieval request data with respect to the personally identifiable information, and verifying the retrieval request matches with the personally identifiable information, and generating a subject-specific login password; and (f) verifying the subject-specific login password, and determining the medical information being accessible to the subject.

The current application claims a foreign priority to application number 103144499 filed on Dec. 19, 2014 in Taiwan

### FIELD OF THE INVENTION

The present invention disclosure is related to a cloud-based retrieval technical field, more specifically, to a method and system for providing a subject access to his/her a cloud-based personal record in a secure and a private environment, e.g., a report or a result of diagnosis, medical examination, and X-ray tests, via the Internet or mobile phone short message service (SMS).

### BACKGROUND OF THE INVENTION

Based on the demand for health and medical examination, a subject (or patient) usually has his/her examination in hospitals, clinics, postpartum care centers, maternity care centers, or other medical examination institutes.

However, the subject cannot receive an examined result immediately after the completion of the medical examination; they need to revisit the institutes where their medical examination was performed to obtain written or oral result for the sake of security and privacy. Revisiting those medical institutes is not only inconvenient, but could also result in additional follow-up examination, leading to a total waste of time.

Furthermore, the medical institutes performing health and medical examination need to deploy a lot of human and physical resources to meet the demand from their subjects and patients.

In view of the foregoing, the present invention is provided to a cloud-based retrieval method of medical information and system thereof to overcome the deficiencies and limitations of prior art, which are described hereinabove.

### SUMMARY OF THE INVENTION

In accordance with a first aspect of the present invention, a cloud-based retrieval method of medical information is provided, in which a subject can access his/her medical information stored in the cloud through an algorithm, it is secure and private.

In accordance with a second aspect of the present invention, the abovementioned cloud-based medical information retrieval method enables the subject to submit a retrieval request data, receive a subject-specific login password online, and privately access subject's medical information stored in the cloud by entering the subject-specific login password and/or at least a part of their personally identifiable information.

In accordance with a third aspect of the present invention, the abovementioned cloud-based medical information retrieval method requires a subject to include at least a part of subject's personally identifiable information in order to obtain the subject-specific login password, so that the subject can access the medial records stored in the cloud securely and privately.

In accordance with a fourth aspect of the present invention, the abovementioned cloud-based medical information retrieval method enables a third party assisting medical examination, including medical technologists, healthcare practitioners, or medical administrators, read and retrieve the medical information of the subject to keep the medical information updated.

In accordance with a fifth aspect of the present invention, a cloud-based medical information retrieval system based on the abovementioned retrieval method is provided.

To achieve the aforementioned and other objectives, the present invention is to provide a cloud-based medical information retrieval method. The method comprises (a) generating an identification code corresponding to a personally identifiable information about a subject; (b) identifying a tested item for the subject to generate a medical information; (c) establishing a connection between the medical information and the subject; (d) submitting a retrieval request data including at least a part of personally identifiable information; (e) executing an algorithm to calculate the retrieval request data with respect to the personally identifiable information, and verifying the retrieval request data matches with the personally identifiable information, and generating a subject-specific login password; and (f) verifying the subject-specific login password, and determining the medical information being accessible to the subject.

To achieve the aforementioned and other objectives, the present invention is to provide a cloud-based medical information retrieval system. In this system, the system applied to a subject use an electronic device to access a medical information with respect to a tested result of a tested item for the subject. The cloud-based medical information retrieval system comprises an examination database, an input unit, an identification unit, an authorization unit, and an inquiry unit. The examination database stores the medical information. The input unit creates an identification code in accordance with a personally identifiable information of the subject. The identification unit is connected the input unit and the examination database, and establishes connection between the subject and the medical information. The authorization unit receives the identification code and a retrieval request data from the subject, the authorization unit calculates the identification code and the retrieval request data for generating a subject-specific login password. The inquiry unit is connected the authorization unit and the identification unit. The inquiry unit verifies the subject by the subject-specific login password, and determines the subject access to the medical information.

Compared to the prior art, the present invention is to provide a subject securely and privately access to his/her medical information via an Internet, enabling the subject to obtain a medical information including diagnosis report and result, outcome of medical and X-ray tests, and text and multimedia information of newborn babies; therefore, the present invention enables the subject to save transportation time and obtain the most updated medical information immediately.

In one embodiment of the present invention, a third party assisting the medical examination, including physicians, medical technologists, healthcare practitioners, or medical administrators, also can read and retrieve the medical information of the subject via the abovementioned method and make a corresponding explanation. In another embodiment, the third party can also provide online diagnosis and treatment services based on the medical information provided in the present invention.

In another embodiment of the present invention, the inquiry unit and an account module share a common platform, and an application programming interface (API) is provided for connecting with multiple medical institutes, so that the medical information of the subject can be retrieved simultaneously in the designated medical institutes via the inquiry unit and the account module.

### BRIEF DESCRIPTION OF THE DRAWINGS

FIG. 1 is a flow chart illustrating the first embodiment of the cloud-based medical information retrieval method in the present invention.

FIG. 2 is a flow chart illustrating the second embodiment of the cloud-based medical information retrieval method in the present invention.

FIG. 3 is an illustrative diagram of the first embodiment of the cloud-based medical information retrieval system in the present invention.

FIG. 4 is an illustrative diagram of the second embodiment of the cloud-based medical information retrieval system in the present invention.

### DETAILED DESCRIPTION OF THE PREFERRED EMBODIMENTS

To fully understand the objectives, characteristics and functions of this invention, selected embodiments will now be explained with reference to the drawings to demonstrate this invention.

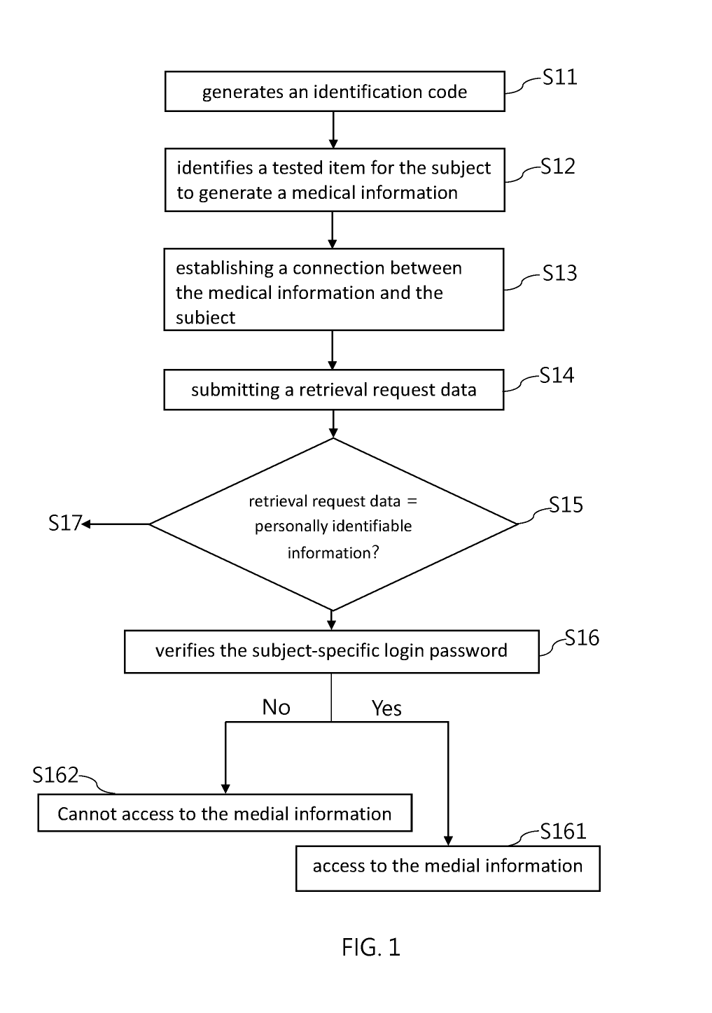

Refer to FIG. 1, which is a flow chart illustrating the first embodiment of the cloud-based medical information retrieval method in accordance with the present invention. In FIG. 1, S11 is the first step that generates an identification code corresponding to a personally identifiable information about a subject. The personally identifiable information can be biological feature data, health insurance data, telephone numbers, media access control (MAC) address of a mobile device, IP address, email accounts, social network accounts, or multiplatform instant messaging application accounts. The identification code can be created based on personally identifiable information, or based on his/her personal medical record, e.g., medical institution codes, serial numbers of medical record, and etc.

In step S12 that identifies a tested item for the subject to generate a medical information. Such as, the medical information like diagnosis report and result, outcome of medical and X-ray test, or information of newborn babies.

In step S13 that establishing a connection between the medical information and the subject. According to connection, the medical information can be linked to the subject. Namely, the medical information can be directed to a specific subject.

In step S14 that submitting a retrieval request data. The retrieval request data comprises at least a part of personally identifiable information. For example, the retrieval request data can be submitted via a network that meets the Internet protocol or mobile network protocol.

In step S15 that executes an algorithm to calculate the retrieval request data with respect to the personally identifiable information, and to verify the retrieval request data matches with the personally identifiable information, and generate a subject-specific login password. Wherein the personally identifiable information is associated with the subject. For example, the subject can submit the subject-specific login password to a specific website. If the retrieval request data matches his/her personally identifiable information, this website will automatically show a login page. The subject can enter the subject-specific login password directly, or can use a mobile phone or tablet to obtain the subject-specific login password first, and then automatically login the specific website by the password.

In this step that identifying whether a part of personally identifiable information is valid and then moving into the next step S16. On the contrary, the corresponding personal identifiable information, the system moves into the step S17. More particularly, in another embodiment of the present invention, the subject-specific login password can be sent to the subject via the Internet or SMS.

In step S16 that verifies the subject-specific login password, and then determines the medical information being accessible to the subject. If the subject-specific login password is correct, the system will move into the step S161; on the contrary, the system moves into the step S162. Specifically, in S161 in FIG. 1, the system identifies the subject-specific login password as valid and permits the subject to access to the medical information. In S162 in FIG. 1, the system identifies the subject-specific login password as invalid and denies the subject to access to the medial information.

In step S17 that the retrieval request data does not match the personally identifiable information, and therefore access to the medical record is denied.

In another embodiment of the present invention, the algorithm of verification process compares the retrieval request data with the personally identifiable information. If the retrieval request data is consisted with at least one part of his/her own personally identifiable information, the identification of the subject can be verified, and the subject-specific login password will be created.

Therefore, after receiving the subject-specific login password, and the subject can read and retrieve the medical record securely without revisiting hospital, postpartum care center, maternity care center, or medical examination institute.

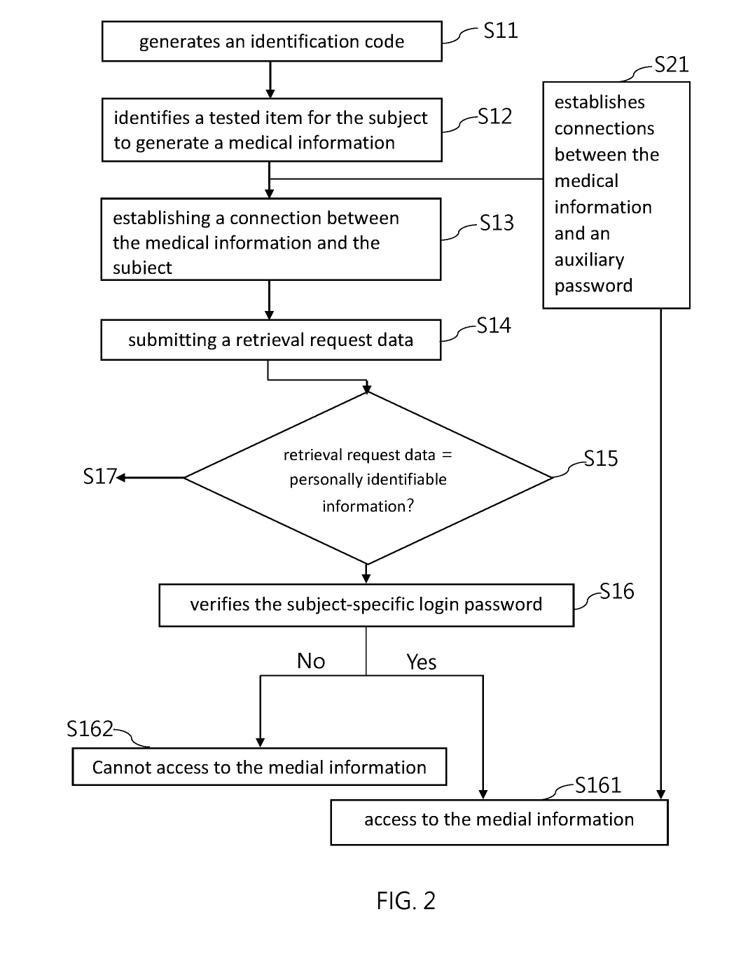

Refer to FIG. 2, which is a flow chart illustrating the second embodiment of the cloud-based medical information retrieval method thereof in accordance with the present invention. In FIG. 2 includes Step S11 to S16 in the first embodiment of the present invention (please refer to FIG. 1), and an additional step S21, which establishes connections between the medical information and an auxiliary password. The auxiliary password corresponds to the personally identifiable information about a third party assisting the medical examination, e.g., physician, medical technologist, healthcare practitioner, or medical administrator.

In this embodiment, in addition to the subject shown in the first embodiment, the abovementioned third party who assist the medical examination can also read and retrieve the medial information, and therefore they can conveniently and simultaneously provide online encounter and other medical services in the cloud.

It is noted that in this embodiment, the method of creating the subject-specific login password to the retrieval request data submitted by subject is also applicable to that submitted by the abovementioned third party, as shown in steps S14 and S15, except for that the third party is assigned to the auxiliary password to access the medical information.

In another embodiment of the present invention, a system administrator can predefine the auxiliary password.

The two embodiment shown in FIG. 1 and FIG. 2 can be constructed by using an application software (APP) or a programming language.

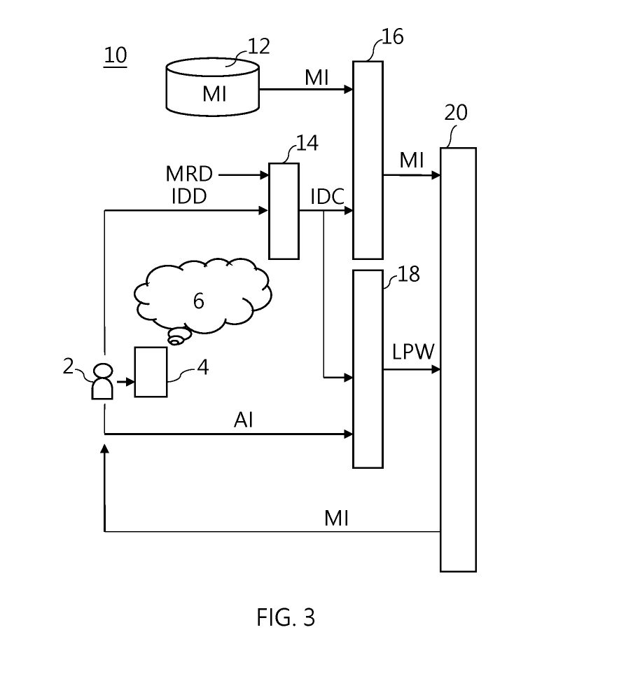

Refer to FIG. 3, which is an illustrative diagram of the first embodiment of the cloud-based medical information retrieval system thereof in the present invention. In FIG. 3, the medical information retrieval system 10 enables a subject 2 to use an electronic device 4 to submit a retrieval request data to inquire a medical information MI. For example, the electronic device 4 can be a mobile device or a tablet, and connects to a network 6 that meets the media access control (MAC) or Internet Protocol (IP). The medical information MI can be diagnosis report and result, outcomes of medical and X-ray test, and text and multimedia information of newborn babies. Specifically, the medical information MI is the result of one tested item in the medical examination (not shown in

FIG. 3) the subject 2 receives. The tested item in the medical examination can be health conditions like heartbeat and blood pressure, bio specimens like hairs, or psychological and physiological conditions in the newborn babies delivered from the subject 2.

The cloud-based medical information retrieval system 10 comprises an examination database 12, an input unit 14, an identification unit 16, an authorization unit 18, and an inquiry unit 20.

The examination database 12 stores the medical information MI. In this embodiment of the present invention, the examination database 12 is installed in the cloud or a dedicated server connected to the network.

The input unit 14 creates an identification code IDC in accordance with the personally identifiable information IDD of the subject 2. The identification code IDC is coded from at least one of the personally identifiable information IDD and a medical record MRD, wherein the medical record MRD can be medical institution code, serial number of medical record, and etc. In one embodiment of the present invention, the subject 2 visits a hospital or a medical institute, and creates the identification code IDC by entering his/her personally identifiable information IDD via card reader. In another embodiment of the present invention, the identification code IDC can also be created by the online hospital appointment system.

The identification unit 16 connects the input unit 14 and the examination database 12, and establishes the connection between the subject 2 and the medical information MI in accordance with the personally identifiable information IDD. The medical information MI is exclusively corresponding to the subject 2; without the permission of the subject 2, any request for access to the medical information MI submitted from someone other than the subjects 2 will be denied.

In this embodiment of the present invention, the identification unit 16 can be medical examination institute, which can identify the tested item of medical examination tested for the subject 2, and then create the medical information MI in accordance with the tested item.

The authorization unit 18 receives the identification code IDC and a retrieval request data AI submitted by the subject 2, executes an algorithm that calculate the identification code IDC and the retrieval request data AI, and generates a subject-specific login password LPW. The retrieval request data AI can be the personally identifiable information IDD or the medical record MRD, or both. The subject-specific login password LPW is sent to the designated APP or electronic device, such as mobile phone, tablet, desktop computer, upon the request from the subject 2 or the system administrator.

The inquiry unit 20 establishes connections between the authorization unit 18 and the identification unit 16, and verify the identification of the subject 2 in accordance with the entry of the subject-specific login password LPW, or the combination of subject-specific login password LPW and the retrieval request data AI. If the subject-specific login password LPW or the combination of the subject-specific login password LPW and the retrieval request data AI is verified to be correct by the inquiry unit 20, the subject 2 can read and retrieve the medical information MI. On the contrary, if the subject-specific login password LPW or the combination of the subject-specific login password LPW and the retrieval request data AI cannot pass the algorithm process of the inquiry unit 20, the subject 2 will not be able to access the medical information MI, and therefore the privacy of MI can be protected.

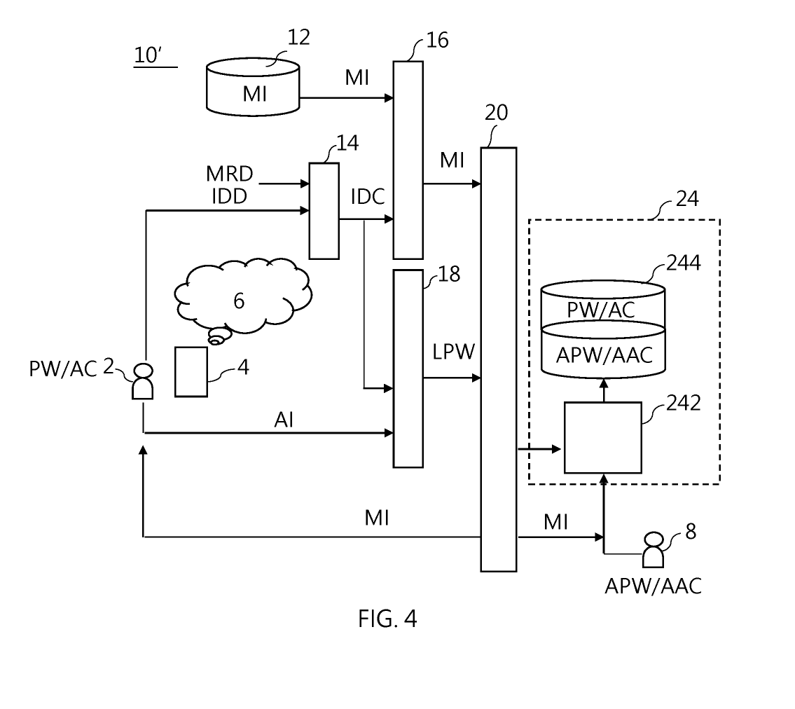

Refer to FIG. 4, which is an illustrative diagram of the second embodiment of the cloud-based medical information retrieval system in the present invention. In FIG. 4, the medical information retrieval system 10′ comprises the components in the first embodiment (shown in FIG. 3), including the examination database 12, the input unit 14, the identification unit 16, the authorization unit 18, and the query unit 20. In addition, the medical information retrieval system 10′ includes an account module 24.

The account module 24 connects to the inquiry unit 20. On the other hand, the account module 24 establishes and stores an account AC and a password PW; both the account AC and the password PW can be used for the account module 24 to connect with the subject-specific login password LPW. To access the medical information MI, the subject 2 needs to fill the inquiry unit 20 with at least one of the subject-specific authorization login password LPW, the account AC and the password PW. In this embodiment of the present invention, the account module 24 comprises a setting unit 242 and an account database 244, which connects the setting unit 242 and the inquiry unit 20. The setting unit 242 establishes the account AC and the corresponding password PW, whereas the account database 244 stores the account AC and the corresponding password PW.

In another embodiment of the present invention, the subject 2 generates the password PW for the account AC in the account module 24 based on his/her subject-specific login password LPW. Therefore, the subject 2 can enter the subject-specific login password LPW to set up, establish, and edit the account AC and the corresponding password PW. In one embodiment of the present invention, the subject 2 can use the account AC and the password PW to login the medical information retrieval system 10′ without entering the subject-specific login password LPW.

In another embodiment of the present invention, the account module 24 establishes an auxiliary account AAC and an auxiliary password APW for the third party 8 who assist the medical examination, including physician, medical technologist, healthcare practitioner, and medical administrator. The medical information MI and The third party 8 can read and retrieve the medical information MI using the auxiliary account AAC and auxiliary password APW that are set up by system administrator or the third party 8. In another embodiments of the present invention, the third party 8 can establish the assistant account AAC and auxiliary password APW in the same method as that for the subject 2 in the account module 24.

The present invention is disclosed by the preferred embodiment in the aforementioned description; however, it is contemplated for one skilled at the art that the embodiments are applied only for an illustration of the present invention rather than are interpreted as a limitation for the scope of the present invention. It should be noted that the various substantial alternation or replacement equivalent to these embodiments shall be considered as being covered within the scope of the present invention. Therefore, the protection scope of the present invention shall be defined by the claims.

What is claimed is:

1. A cloud-based medical information retrieval method comprising:
(a) generating an identification code corresponding to a personally identifiable information about a subject;
(b) identifying a tested item for the subject to generate a medical information;
(c) establishing a connection between the medical information and the subject;
(d) submitting a retrieval request data including at least a part of personally identifiable information;
(e) executing an algorithm to calculate the retrieval request data with respect to the personally identifiable information, and verifying the retrieval request data matches with the personally identifiable information, and generating a subject-specific login password; and
(f) verifying the subject-specific login password, and determining the medical information being accessible to the subject.

2. A cloud-based medical information retrieval method as claimed in claim 1, wherein the identification code is consisted of the personally identifiable information, a medical record, or both.

3. A cloud-based medical information retrieval method as claimed in claim 1, wherein in the step (e) further comprises the subject-specific login password to be sent to the subject via a network which meets a Mobile Communication Protocol or an Internet Protocol.

4. A cloud-based medical information retrieval method as claimed in claim 1, further comprising step (g), establishing an auxiliary password is linked to the medical information and exclusively corresponding to a personally identifiable information of a third party.

5. A cloud-based medical information retrieval method as claimed in claim 4, wherein after step (g) further comprises step (h), verifying the auxiliary password to determine the third party obtain the medical information.

6. A cloud-based medical information retrieval system, applied to a subject use an electronic device to access a medical information with respect to a tested result of a tested item for the subject, the cloud-based medical information retrieval system comprising:
an examination database storing the medical information;
an input unit creating an identification code in accordance with a personally identifiable information of the subject;
an identification unit connecting the input unit and the examination database, and establishing connection between the subject and the medical information;
an authorization unit receiving the identification code and a retrieval request data from the subject, the authorization unit calculating the identification code and the retrieval request data for generating a subject-specific login password; and
an inquiry unit connecting the authorization unit and the identification unit, the inquiry unit verifying the subject by the subject-specific login password, and determining the subject access to the medical information.

7. A cloud-based medical information retrieval system as claimed in claim 6, further comprising an account module linked with the inquiry unit, the account module creates and stores an account and a password whereby the subject enters the account and the password to access the medical information.

8. A cloud-based medical information retrieval system as claimed in claim 7, wherein the subject change the password via the account module after the account module allow the subject to use by the subject-specific login password.

9. A cloud-based medical information retrieval system as claimed in claim 7, wherein the account module creates and stores an auxiliary account and an auxiliary password for a third party, the auxiliary account is associated with the medical information, the third party retrieves medical information via the auxiliary account and the password.

10. A cloud-based medical information retrieval system as claimed in claim 7, wherein the account module further comprises a setting unit and an account database, the account database is connected with the setting unit and the inquiry unit, the setting unit creates the account and the password, and the account database stores the account and the password.
